(19) United States
(12) Patent Application Publication
(10) Pub. No.: US 2013/0089049 A1
(43) Pub. Date: Apr. 11, 2013

(54) METHOD AND APPARATUS FOR BEACON SCHEDULING IN WIRELESS COMMUNICATION SYSTEM

(71) Applicant: Electronics and Telecommunications Research Institute, Daejeon (KR)

(72) Inventors: Young Ae Jeon, Daejeon (KR); Sangsung Choi, Daejeon (KR); Kwang-il Hwang, Seoul (KR); Woonyong Lee, Incheon (KR)

(73) Assignee: Electronics and Telecommunications Research Institute, Daejeon (KR)

(21) Appl. No.: 13/649,618

(22) Filed: Oct. 11, 2012

(30) Foreign Application Priority Data
Oct. 11, 2011 (KR) 10-2011-0103683

(51) Int. Cl. H04W 72/04

(52) U.S. Cl. 370/329

(57) ABSTRACT

A first device to enter a wireless network actively performs a connection request by transmitting a connection request message, and a second device, having received the connection request message, sets a candidate slot value and transmits a candidate superframe slot notification message corresponding thereto to the first device. Accordingly, the first device performs beacon scheduling that allocates a superframe slot according to a candidate slot value.

### CROSS-REFERENCE TO RELATED APPLICATION

This application claims priority to and the benefit of Korean Patent Application No. 10-2011-0103683 filed in the Korean Intellectual Property Office on Oct. 11, 2011, the entire contents of which are incorporated herein by reference.

### BACKGROUND OF THE INVENTION

(a) Field of the Invention

The present invention relates to a method and apparatus for scheduling. More particularly, the present invention relates to a method and apparatus for performing fast beacon scheduling in a mesh-based wireless communication system.

(b) Description of the Related Art

As the demand for new applications that can satisfy various user requests that change every moment increases, short range wireless individual communication network technology has been continuously developed, and a research on related communication specifications has been performed.

Nowadays, in order to form an optimal solution according to a specific service area rather than to form a personal area network (PAN) by a media access control (MAC) technology specification, by providing a plurality of MAC modes, a user can select a MAC mode according to a specific service purpose and operate a network. A provided plurality of MAC modes include a low latency (LL) mode, a time slotted channel hopping (TSCH) mode, and a deterministic and synchronous multi-channel extension (DSME) mode.

In a DSME mode, a method of performing beacon scheduling is performed based on a multi-superframe structure. Specifically, each node manages a superframe duration (SD) index of apparatuses at a periphery thereof and transmits an SD bitmap of adjacent nodes to an enhanced beacon. The SD bitmap represents beacon slot information of each apparatus that is allocated within a present beacon interval.

A node to participate in a network performs a passive scan for all channels, and when a beacon is received, the node allocates a superframe thereof so that SD indexes of adjacent nodes of a predetermined hop (e.g., 2 hops) do not overlap based on the SD bitmap that is included in the received beacon, and the node broadcasts a beacon allocation notification command including an SD index of the allocated superframe. An apparatus having received the beacon allocation notification command determines whether the beacon allocation notification command overlaps with an SD index value of adjacent nodes, and when the corresponding SD index already exists, the apparatus transmits a beacon collision notification and notifies that the corresponding index overlaps. A node having received the beacon collision notification selects another slot among empty slots on a bitmap and again performs beacon allocation. Resultantly, a collision does not occur through such a process, and superframes of entire nodes are allocated within one beacon period.

However, in such a beacon scheduling method, each apparatus receives a beacon from adjacent nodes through a manual scanning process over all channels and sends a request to participate to the network to a corresponding apparatus through beacon information. In this case, when a node of a far distance from a PAN coordinator that first starts beacon transmission waits for a considerably long period, the node has an opportunity to be connected to the network and thus a long time is requested in forming an entire network.

Further, in order to store superframe information of an adjacent node, when a bitmap is used, the bitmap size increases in proportion to a network size, and thus when a network size increases, bitmap space of the network size is necessary. In general, it is difficult to estimate an entire network size, and the used bitmap changes according to connection topology of adjacent nodes and thus allocation of a bitmap of a sufficient size is requested, whereby storage space for beacon scheduling is wasted.

Further, by transmitting bitmap information to a beacon frame, variability and an increase of a beacon frame size is caused.

Further, in an existing beacon scheduling method, a latent collision possibility still exists, and as a node connection depends on only beacon reception, there is a possibility that the node cannot receive a beacon and thus a network of a specific node may not be connected.

Further, for beacon scheduling, slot values that are allocated to all adjacent nodes every time are compared, and the slot values should be expressed with the bitmap and stored and transmitted and thus due to the overhead, the scheduling algorithm may become complicated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for beacon scheduling having advantages of shortening a network forming time.

The present invention has been made in an effort to further provide a method and apparatus for beacon scheduling having advantages of minimizing a beacon frame size while using minimal storage space.

The present invention has been made in an effort to further provide a method and apparatus for beacon scheduling having advantages of reusing a slot having no mutual interference.

An exemplary embodiment of the present invention provides a method of performing beacon scheduling in a wireless network, the method including: transmitting, by a first device to enter the wireless network, a connection request message; receiving, by the first device, a candidate superframe slot notification message including a candidate slot value from a second device that receives the connection request message; and allocating, by the first device, a superframe slot according to a candidate slot value.

The first device may broadcast the connection request message as soon as the first device is in a wakeup state. The first device may transmit the connection request message over all channels and receive the candidate superframe slot notification message after a predetermined time has elapsed.

Each device that enters the wireless network may manage index information including a superframe index value of a superframe that is allocated to transmit a beacon signal of adjacent nodes and a representative superframe index value for beacon scheduling.

The allocating of a superframe slot may include: setting, by the first device, a representative superframe index value thereof according to the candidate slot value; and setting, by the first device, a superframe index value thereof and allocating a superframe according to the candidate slot value.

The method may further include broadcasting, by the first device, a superframe use notification message including information about the allocated superframe.

Another embodiment of the present invention provides a method of performing beacon scheduling in a wireless network, the method including: receiving, by a second device that enters the wireless network, a connection request message from a first device; setting, by the second device, a value that is a sum of a preset value and a representative superframe index value thereof as a candidate slot value; and transmitting, by the second device, a candidate superframe slot notification message including a candidate slot value and an identifier thereof to the first device.

The method may further include: receiving, by the second device, a superframe use notification message including information that is related to superframe slot allocation of a network device from the network device including the first device; and selectively changing, by the second device, superframe allocation thereof based on the information that is included in the superframe use notification message.

The information that is included in the superframe use notification message may include a superframe index value corresponding to a superframe that is allocated to the network device, an identifier of a parent node of the network device, and a superframe index value corresponding to a superframe that is allocated to the parent node.

The selectively changing of superframe allocation may include first comparing of comparing a superframe index value of the network device that is extracted from the received superframe use notification message and a representative superframe index value of the second device; second comparing of comparing a parent identifier that is extracted from the received superframe use notification message and an identifier of the second device; third comparing of comparing a superframe index value of a parent node of the network device that is extracted from the received superframe use notification message and a superframe index value of the second device; and selectively resetting a representative superframe index value of the second device and a superframe index value of the second device based on at least one of a comparison result of the first comparing, a comparison result of the second comparing, and a comparison result of the third comparing.

The selectively resetting of a representative superframe index value may include at least one of: first resetting of maintaining each of a representative superframe index value of the second device and a superframe index value of the second device at existing values; second resetting of resetting a representative superframe index value of the second device by increasing by a predetermined value according to a preset value and maintaining a superframe index value of the second device at an existing value; and third resetting by increasing the representative superframe index value of the second device according to a preset first value, resetting a representative superframe index value that is increased according to the first value to the reset representative superframe index value of the second device by increasing according to a preset second value, and resetting a superframe index value of the second device according to the reset representative superframe index value of the second device.

Yet another embodiment of the present invention provides an apparatus that performs beacon scheduling in a wireless network, the apparatus including: a connection request unit that broadcasts a connection request message that requests a connection to the wireless network; a candidate slot receiving unit that receives a candidate superframe slot notification message including a candidate slot value from a device that has already joined the wireless network; and a slot allocation unit that that performs superframe allocation according to a candidate slot value that is extracted from the candidate superframe slot notification message, wherein the candidate slot value is a value that is a sum of a preset value and a representative superframe index value corresponding to a superframe that is allocated to a device that transmits the candidate superframe slot notification message.

The apparatus may further include: a use notification unit that generates and broadcasts a superframe use notification message including a superframe index value corresponding to superframe allocation by the slot allocation unit, an identifier of a device that transmits the candidate superframe slot notification message, and a superframe index value of a device that transmits the candidate superframe use notification message; and a collision avoiding unit that determines, when a superframe use notification message is received from another device on the wireless network, whether to change a superframe index value thereof based on a superframe index value of another device that is extracted from the received message and that selectively changes a superframe index value thereof according to a determination result.

### BRIEF DESCRIPTION OF THE DRAWINGS

FIG. 1 is a diagram illustrating a structure of a superframe.

FIG. 2 is a diagram illustrating an example of performing beacon scheduling using a bitmap in a wireless network system.

FIG. 3 is a diagram illustrating an environment in which a latent collision occurs when performing beacon scheduling using a bitmap.

FIGS. 4 to 6 are flowcharts illustrating a method of performing beacon scheduling according to an exemplary embodiment of the present invention.

FIG. 7 is a diagram illustrating a network environment to which a beacon scheduling method is applied according to an exemplary embodiment of the present invention.

FIG. 8 is a diagram illustrating a superframe slot that is allocated to each node according to the beacon scheduling of FIG. 7.

FIG. 9 is a diagram illustrating a process of avoiding a beacon collision with a method of performing beacon scheduling according to an exemplary embodiment of the present invention.

FIG. 10 is a block diagram illustrating a configuration of a beacon scheduling apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

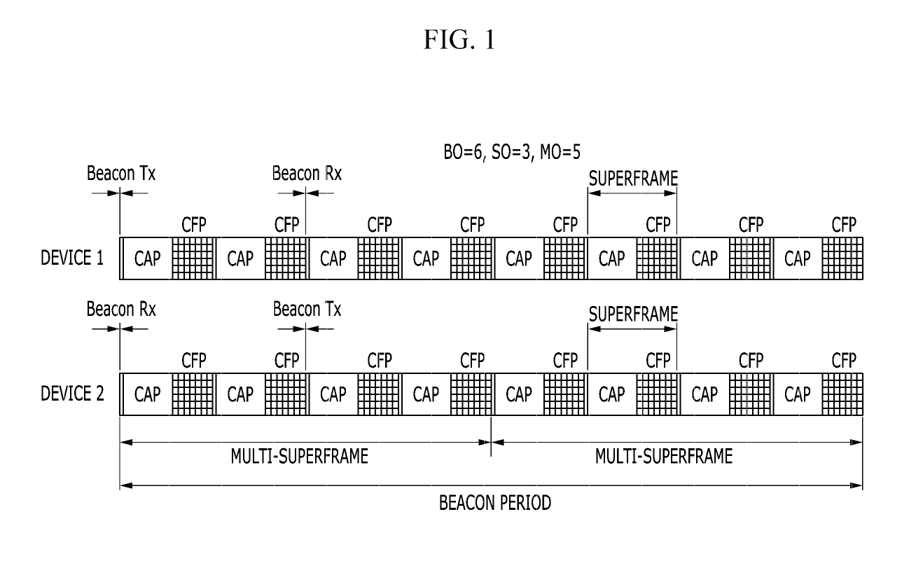

FIG. 1 is a diagram illustrating a structure of a superframe. Each node constituting a network operates in an active state and an inactive state, and for duty-cycling that repeats the active state and inactive state, each node performs beacon scheduling that manages a transmission time of a beacon using a superframe.

As shown in FIG. 1, the superframe includes a beacon period (beacon Tx and beacon Rx) that transmits/receives a beacon and a contention access period (CAP) that approaches a channel with a carrier sense multiple access/collision avoidance (CSMA/CA) method, and selectively includes a contention free period (CFP) and an inactive period that prevents power consumption. Here, the beacon period and the CAP are referred to as an active period, and the active period may be adjusted using a parameter of a superframe order (SO) and a beacon order (BO). The SO is related to a length of a superframe, and the BO is related to a beacon interval (BI), which is an interval in which a PAN coordinator (PNC), which is an uppermost-level node that starts and manages a network and transmits a beacon frame. A superframe duration (SD) is formed in a slot. A node within the network receives information from an adjacent node thereof and selects an empty SD, thereby performing beacon scheduling.

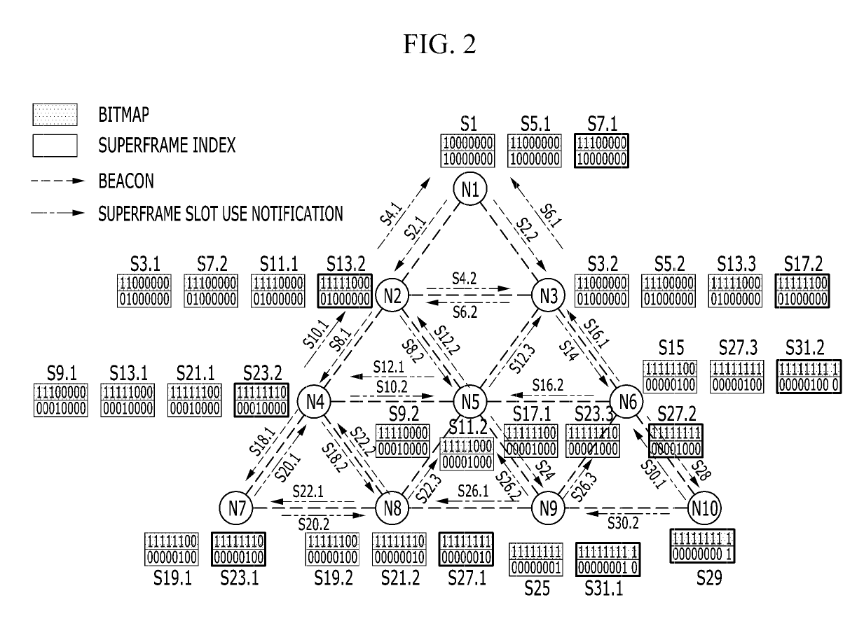

FIG. 2 is a diagram illustrating an example of performing beacon scheduling using a bitmap in a wireless network system.

As shown in FIG. 2, each node is a child node and is also a parent node, and in order to know whether nodes to be connected to each node exist, each node continues to broadcast a beacon frame and scans an available frequency channel. Beacon allocation information is expressed with the bitmap, and each node selects a superframe having an empty slot as a superframe for transmitting a beacon thereof from the bitmap.

For example, as shown in FIG. 1, a node (N1) sets a bitmap value thereof to “1000 0000” and an index value of a superframe thereof to “1000 0000” (S1). The N1 broadcasts a beacon through a superframe thereof, and thus a node 2 (N2) and a node (N3) receive the beacon (S2.1 and S2.2).

After the N2 and N3 have received the beacon set bitmap and superframe index values thereof, the N2 sets “1100 0000” as a bitmap value and “0100 0000” as a superframe index value (S3.1). Further, the N3 sets “1100 0000” as a bitmap value and “0100 0000” as a superframe index value (S3.2).

Thereafter, the N2 broadcasts a superframe slot use notification message including a preset bitmap value and superframe index value (S4.1 and S4.2). The N1, having received the superframe slot use notification message changes a bitmap value thereof from “1000 0000” to “1100 0000” and sustains a superframe index value thereof “1000 0000” (S5.1).

Further, the N3, having received the superframe slot notification message, changes a bitmap value thereof from “1100 0000” to “1110 0000”. However, as a superframe index value that is included in the received superframe slot use notification message corresponds with a superframe index value thereof, the N3 changes a superframe index value thereof from “0100 0000” to “0010 0000” (S5.2). The N3 broadcasts a superframe slot use notification message including the changed superframe index value (S6.1 and S6.2).

The N1, having received the superframe slot use notification message from the N3, changes a bitmap value thereof from “1100 0000” to “1110 0000” and maintains a superframe index value of “1000 0000” (S7.1). Further, the N2, having received the superframe slot notification message, changes a bitmap value thereof from “1100 0000” to “1110 0000” and maintains a superframe index value of “0100 0000” (S7.2).

In this way, the N2 and N3 perform scheduling that sets a superframe without collision according to beacon transmission from the N1.

Thereafter, as the N2 transmits a beacon, a node 4 (N4) and a node 5 (N5) set a superframe index value thereof according to the received beacon through the above-described process. That is, the N4 sets a superframe index value thereof to “0001 0000” (S13.1), and the N5 sets a superframe index value thereof to “0000 1000” (S11.2). The N3 maintains a superframe index value of “0010 0000” (S13.3).

Further, as the N3 transmits a beacon, the N5 and N6 set a superframe index value thereof according to the received beacon through the above-described process. That is, the N5 maintains a superframe index value of “0000 1000”, and the N6 sets a superframe index value thereof to “0000 0100” (S15).

The N2 to N6 perform scheduling that sets a superframe without collision through such a process.

When the N4 broadcasts a beacon, a node 7 (N7) and a node 8 (N8) set a superframe index value thereof according to the received beacon through the above-described process. That is, the N7 sets a superframe index value thereof to “0000 0100” (S23.1), and the N8 sets a superframe index value thereof to “0000 0010” (S27.1). The N4 maintains a superframe index value of “0001 0000” (S23.2), and the N5 maintains a superframe index value of “0000 1000” (S23.3).

Further, when the N5 broadcasts a beacon, a node 9 (N9) sets a superframe index value thereof according to the received beacon through the above-described process. That is, the N9 sets a superframe index value thereof to “0000 0001” (S25). The N8 maintains a superframe index value of “0000 0010” (S27.1), and the N6 maintains a superframe index value of “0000 0100” (S27.3).

Further, when the N6 broadcasts a beacon, a node 10 (N10) sets a superframe index value thereof according to the received beacon through the above-described process. That is, the N10 sets a superframe index value thereof to “0000 0000 1” (S29). The N9 maintains a superframe index value of “0000 0001” (S31.1), and the N6 maintains a superframe index value of “0000 0100” (S31.2).

Each node may set a superframe to transmit a beacon without collision through beacon scheduling using the above-described bitmap.

However, upon performing such beacon scheduling, a possibility of collision occurrence is high.

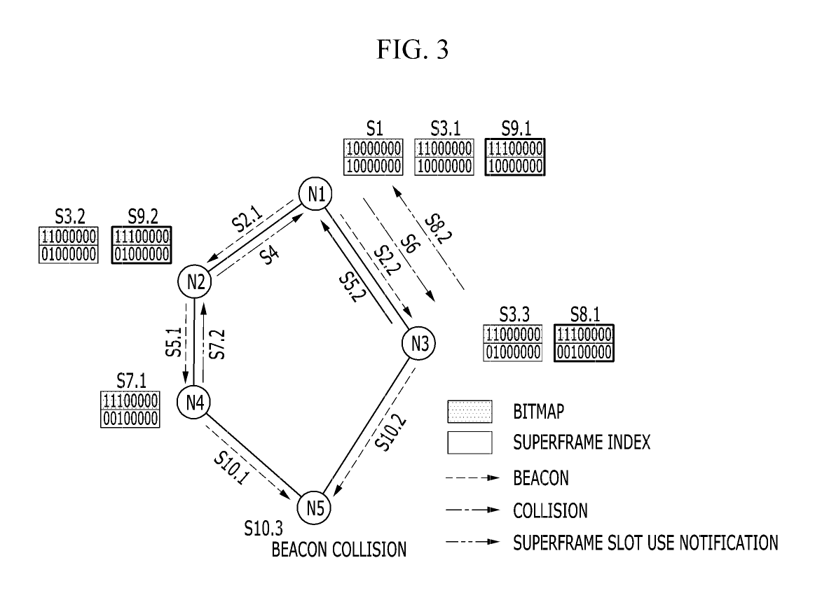

FIG. 3 is a diagram illustrating an environment in which a latent collision occurs when performing beacon scheduling using the bitmap.

In the above-described bitmap-based beacon scheduling, the smallest slot of empty slots is selected. In this case, in topology that forms 1 hop, because nodes that do not hear each other allocate the same slot, beacons of two nodes that are transmitted from the same slot collide and thus a node that should perform a connection by a beacon cannot receive the beacon. As a result, a corresponding node can never be connected to the network.

More specifically, as shown in FIG. 3, when the N1 sets a bitmap value thereof to “1000 0000”, sets a superframe index value thereof to “1000 0000” (S1), and broadcasts a beacon, the N2 and N3 receive the beacon (S2.1 and S2.2).

Accordingly, the N2 sets a bitmap value thereof to “1100 0000” and a superframe index value thereof to “0100 0000” (S3.2), and the N3 sets a bitmap value thereof to “1100 0000” and sets a superframe index value thereof to “0100 0000” (S3.3). Thereafter, the N2 broadcasts a superframe slot use notification message (S4), and the N3 broadcasts a superframe slot use notification message (S5.2). The N2 broadcasts a beacon (S5.1).

In this way, as the N2 and N3 use the same superframe index value, the N1 transmits a collision message to the N3 (S6). Accordingly, the N3 sets a bitmap value thereof to “1110 0000” and changes a superframe index value thereof to “0010 0000” according to a collision message (S8.1).

The N4, having received the beacon from the N2 sets a bitmap value thereof to “1110 0000” and a superframe index value thereof to “0010 0000” (S7.1). The N4 broadcasts a superframe slot use notification message (S7.2). The N2, having received the superframe slot use notification message from the N4 changes and sets a bitmap value thereof from “1100 0000” to “1110 0000” and maintains the superframe index value of “0100 0000” (S9.2). Further, the N3 transmits the superframe slot use notification message to the N1. The N1, having received the superframe slot use notification message from the N3 changes a bitmap value thereof from “1100 0000” to “1110 0000” and maintains the superframe index value of “1000 0000” (S9.1).

According to such beacon scheduling, in a state in which the N3 and N4 set the same superframe index value “0010 0000”, when the N3 and N4 broadcast a beacon, a beacon collision occurs and thus the N5 does not receive the beacon (S10.1 and S10.2).

In this way, when performing beacon scheduling based on a bitmap under an environment of FIG. 3, in topology that forms 1 hop, the same slot is allocated to nodes that do not hear each other and thus a beacon collision may occur.

In an exemplary embodiment of the present invention, beacon scheduling is not performed based on a bitmap, but beacon scheduling is performed based on a representative superframe slot index and an active connection request.

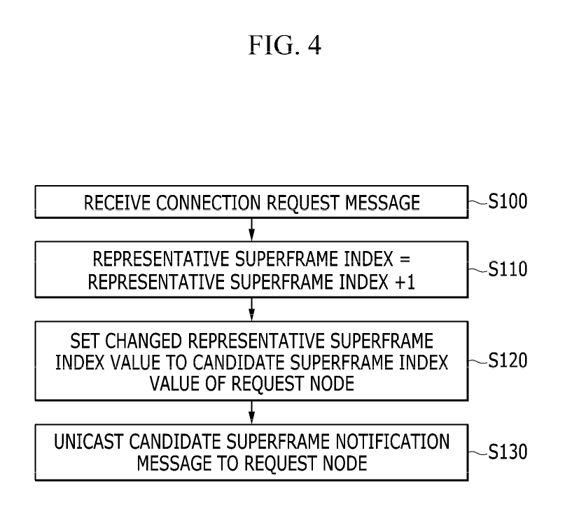

FIGS. 4 to 6 are flowcharts illustrating a method of performing beacon scheduling according to an exemplary embodiment of the present invention.

In an exemplary embodiment of the present invention, a device wanting a connection of a wireless network actively requests connection to a network instead of being connected through a manual channel scan process.

In an exemplary embodiment of the present invention, each device includes a table that manages information about an adjacent node and includes a table that manages representative superframe index information. Each device uses a representative superframe index in addition to an index corresponding to a slot of a superframe for transmitting a beacon on a node basis. Therefore, representative superframe index information that each node manages includes an index value of a substantially used superframe and a representative superframe index value that is set to correspond thereto.

In an exemplary embodiment of the present invention, a candidate slot value is allocated using a representative superframe index value according to a connection request, and when a superframe is set according to such a candidate slot value, by resetting a superframe using a representative superframe index value, an identifier ID, and a superframe index value, a beacon collision is prevented.

FIG. 4 is a flowchart illustrating a processing process according to a connection request in a method of performing beacon scheduling according to an exemplary embodiment of the present invention.

A device (hereinafter referred to as a ‘first device’) that wants a connection to a wireless network actively broadcasts a connection request message over all channels. Here, the device may broadcast a connection request message according to carrier sense multiple access/collision avoidance (CSMA/CA), and may broadcast a connection request message in order over all channels.

Among other devices having received a connection request message from the first device, a device that has already joined the network performs the following candidate superframe slot allocation process (S100).

A device (hereinafter referred to as a ‘second device’) having received a connection request message adds a predetermined value (e.g., 1) to a present representative superframe index value thereof (S110). The second device sets a representative superframe index value to which a predetermined value is added to a candidate superframe of the first device that requests a connection (S120).

Thereafter, the second device performs unicast of a candidate superframe slot notification message including an index value, i.e., a candidate slot value of a preset candidate superframe, to the first device (S130). An identifier (e.g., ID) of a device that transmits a message and a superframe index value of the device are additionally stored in the candidate superframe slot notification message. Here, an identifier of the first device and a superframe index value are included in the transmitted candidate superframe slot notification message.

Hereinafter, a processing process when transmitting a connection request message and receiving a candidate superframe slot notification message will be described.

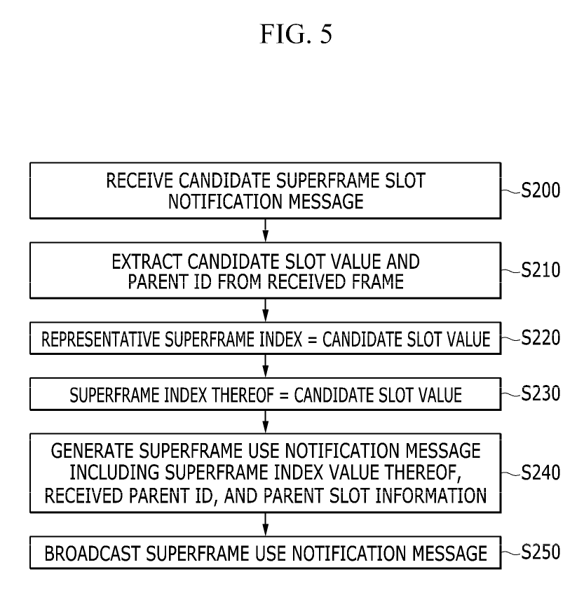

FIG. 5 is a flowchart illustrating a process of processing a candidate superframe slot notification message in a method of performing beacon scheduling according to an exemplary embodiment of the present invention.

When a device, i.e., a first device, having transmitted a connection request message receives a candidate superframe slot notification message that is transmitted from a device, i.e., a second device that has been already entered a network (S200), the first device extracts a candidate slot value and ID (hereinafter referred to as ‘parent ID’) of the device that transmits the message from the received message (S210).

The first device sets a representative superframe index value and a superframe index value thereof according to the extracted candidate slot value (S220 and S230). That is, the first device sets a candidate slot value to a representative superframe index value thereof and a candidate slot value to a superframe index value thereof.

The first device generates a superframe use the notification message including a new superframe index value thereof, parent ID thereof (e.g., ID of the second device), and slot information of the parent node, and broadcasts the generated superframe use notification message (S240 and S250). Here, the slot information of the parent node includes a superframe index value of the parent node.

Hereinafter, an operating process of a device that receives such a superframe use notification message will be described.

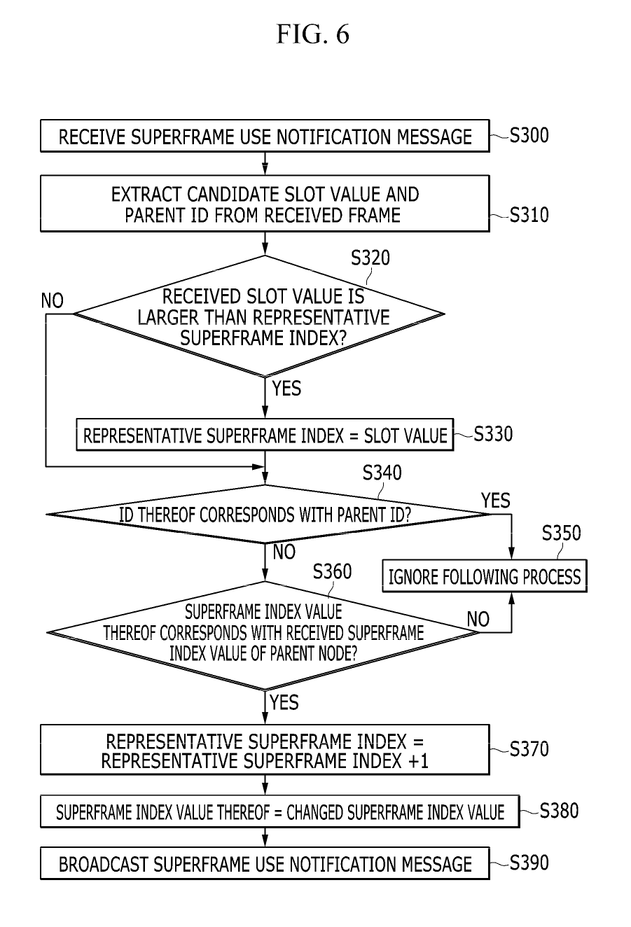

FIG. 6 is a flowchart illustrating a process of processing a superframe use notification message in a method of performing beacon scheduling according to an exemplary embodiment of the present invention.

A device (hereinafter, for convenience of description, referred to as a ‘third device’, and the third device may be a second device) having received a superframe use notification message extracts a slot value to use, i.e., a superframe index value of a child node (here, a first device), parent ID, and a superframe index value of a parent node from the received message (S300 and S310).

The third device compares an extracted superframe index value of the child node and a representative superframe index value thereof (S320). If a superframe index value of a child node that is extracted from the received message is larger than a representative superframe index value thereof, the third device changes a representative superframe index value thereof according to the extracted superframe index value of the child node (S330).

If a superframe index value of a child node that is extracted from the received message is not larger than a representative superframe index value thereof, the third device determines whether ID thereof corresponds with the extracted parent ID (S340). If the ID thereof corresponds with the extracted parent ID, the following process is ignored and terminated (S350). In such a case, the representative superframe index value and the superframe index value maintain existing values.

If the ID thereof does not correspond with the extracted parent ID, the third device compares a superframe index value thereof with a superframe index value of the parent node that is extracted from the received message (S360). If a superframe index value thereof corresponds with a superframe index value of the parent node that extracts from the received message, the third device increases a representative superframe index value thereof by a predetermined value (e.g., 1) (S370). The third device changes a superframe index value thereof according to the increased value (S380). The third device broadcasts a superframe use notification message including the changed superframe index value (S390).

If a superframe index value thereof does not correspond with a superframe index value of the parent node that is extracted from the received message, the third device ignores the following process (S350). Accordingly, the representative superframe index value and the superframe index value of the third device maintain existing values.

Even when a representative superframe index value thereof is changed according to a superframe index value of a child node that is extracted at step S330, the third device determines whether the ID thereof corresponds with the extracted parent ID, and if the ID thereof corresponds with the extracted parent ID, the following process is ignored and terminated. In such a case, only a representative superframe index value of the third device is reset to a changed value at step S330, and a superframe index value of the third device maintains an original value.

However, after a representative superframe index value thereof is changed according to an extracted superframe index value of a child node at step S330, when the ID thereof does not correspond with the extracted parent ID and when a superframe index value thereof corresponds with a superframe index value of the parent node that is extracted from the message, the representative superframe index value thereof that is changed at step S330 is again set by increasing by a predetermined value (e.g., +1), and thus a superframe index value thereof is also changed, whereby a beacon collision is avoided.

When a superframe index value of a child node that is extracted from the received message is not larger than a representative superframe index value thereof, when the ID thereof does not correspond with the extracted parent ID, and when a superframe index value thereof corresponds with a superframe index value of the parent node that is extracted from the message, a present representative superframe index value thereof is set again by increasing by a predetermined value, a superframe index value thereof is also changed, and thus a beacon collision is avoided.

As a preset superframe index value of the second device is set to a value that does not collide with superframe index values of other devices through such a process, the second device can transmit a beacon signal through a superframe corresponding to a preset superframe index value.

As a result, various problems such as a long network forming time, waste of storage space, variability and increase of a beacon frame size, and complexity of the algorithm occurring upon performing existing beacon scheduling can be solved.

Hereinafter, a method of performing beacon scheduling based on such processes according to an exemplary embodiment of the present invention will be described in detail using an index value.

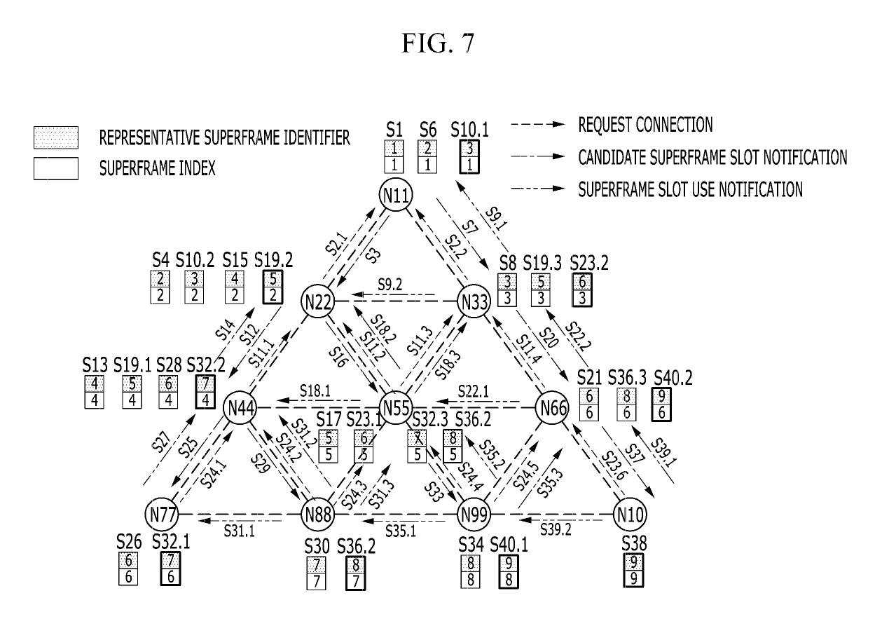

FIG. 7 is a diagram illustrating a network environment to which a beacon scheduling method is applied according to an exemplary embodiment of the present invention.

Each device attempts to enter a network by transmitting a connection request message in a wake up state. A device, i.e., a node that has been already entered the network among devices, having received a connection request message, notifies a corresponding candidate slot value by previously allocating a candidate slot based on present representative superframe index information thereof. A device having received the candidate slot value allocates a slot thereof according to the candidate slot value, performs use notification thereof, and notifies adjacent nodes of the device of a slot that the device uses. Particularly, in an exemplary embodiment of the present invention, slot allocation information of an adjacent node is represented by a representative superframe index, and a slot can be reused between nodes that are separated by 2 hops or more. In spite of increase of nodes, allocation information management of an adjacent node and a slot thereof may be expressed with a fixed value.

Referring to FIG. 7, for example, a node 1 (N11) that has already entered a network sets a representative superframe index value thereof to “1” and sets a superframe index value thereof to “1” based on such a process (S1). In such a state, a node 2 (N22) and a node 3 (N33) that want a connection of the network broadcast a connection request message (S2.1 and S2.2).

The N11, having received the connection request message, increases a representative superframe index value thereof by +1 to change the representative superframe index value to “2”, and sets the changed representative superframe index value “2” as a candidate slot value. The N11 transmits a candidate superframe slot notification message including the candidate slot value “2” and the ID thereof to the N22 (S3).

The N22, having received a candidate superframe slot notification message that is transmitted from the N11 sets a representative superframe index value thereof to “2” and a superframe index value thereof to “2” according to a candidate slot value “2” that is extracted from a candidate superframe slot notification message (S4). The N22 broadcasts a superframe slot use a notification message including a preset superframe index value and parent ID (i.e., the ID of the node 1) and a superframe index value (i.e., a superframe index value “2” of the node 1) of the parent node.

Because a superframe index value of the node 2 that is extracted from the superframe slot use notification message is “2” and is larger than a representative superframe index value thereof of “1”, the N11, having received the superframe slot use notification message, changes a representative superframe index value thereof from “1” to “2” (S6). Because the ID thereof and the parent ID that is extracted from the message are the same, the N11 maintains a superframe index value of “1”.

When the N11 receives a connection request message that is transmitted from the N33, the N11 transmits a candidate superframe slot notification message to the N33 (S3). In this case, the N11 includes a candidate slot value “3” that increases a representative superframe index value thereof of “2” by +1 and the ID thereof in a candidate superframe slot notification message, and transmits the candidate superframe slot notification message.

The N33 receives the candidate superframe slot notification message from the N11 and sets a representative superframe index value thereof to “3” and a superframe index value thereof to “3” according to a candidate slot value that is extracted from the received candidate superframe slot notification message (S8). The N33 broadcasts a superframe slot use notification message including a preset superframe index value, parent ID (i.e., ID of the node 1), and a superframe index value (here, a superframe index value “1” of the node 1) of a parent node (S9.1 and S9.2).

Because the superframe index value of the node 3 that is extracted from the superframe slot use notification message is “3” and is larger than a representative superframe index value thereof of “2”, the N11, having received the superframe slot use notification message from the N33, changes a representative superframe index value thereof from “2” to “3”. Because the ID thereof and the parent ID that is extracted from the message are the same, the N11 maintains a superframe index value thereof of “1” (S10.1).

Further, because a superframe index value of the node 3 that is extracted from the superframe slot use notification message is “3” and is larger than a representative superframe index value thereof of “2”, the N22, having received the superframe slot use notification message that is transmitted from the N33, changes and sets a representative superframe index value thereof from “2” to “3”. The ID of the N22 and the parent ID that is extracted from the received message are different, but because a superframe index value thereof of “2” is different from a superframe index value (here, a superframe index value “1” of the node 1) of the parent node that is extracted from the received message, the N22 maintains a superframe index value thereof of “2” (S10.2).

In this way, in a state in which the N22 and N33 enter the network, in order for a node 4 (N44), a node 5 (N55), and a node 6 (N66) to enter the network, the N44, N55, and N66 broadcast a connection request message (S11.1, S11.2, S11.3, and S11.4).

The N22, having received the connection request message, transmits a candidate superframe slot notification message to the N44 (S12). In this case, the N22 includes a candidate slot value “4” that increases a representative superframe index value thereof of “3” by +1 and the ID thereof in a candidate superframe slot notification message, and transmits the candidate superframe slot notification message.

The N44, having received the candidate superframe slot notification message from the N22, sets a representative superframe index value thereof to “4” and a superframe index value thereof to “4” according to a candidate slot value (S13). The N44 broadcasts a superframe slot use notification message including the superframe index value thereof, parent ID (i.e., ID of the node 2), and a superframe index value (here, a superframe index value “2” of the node 2) of a parent node (S14).

Because the superframe index value of the node 4 that is extracted from the superframe slot use notification message is “4” and is larger than a representative superframe index value thereof of “3”, the N22, having received the superframe slot use notification message from the N44, changes and sets a representative superframe index value thereof from “3” to “4” and maintains a superframe index value thereof of “2” (S15).

The N22, having received a connection request message from the N55, transmits a candidate superframe slot notification message to the N55 (S16). Here, the N22 includes a candidate slot value “5” that increases a representative superframe index value thereof of “4” by +1 and the ID thereof in a candidate superframe slot notification message, and transmits the candidate superframe slot notification message.

The N55, having received the candidate superframe slot notification message from the N22, sets a representative superframe index value thereof to “5” and a superframe index value thereof to “5” according to the candidate slot value (S17). The N55 broadcasts a superframe slot use notification message including such a superframe index value, parent ID (i.e., ID of the node 2), and a superframe index value of a parent node (here, the superframe index value “2” of the node 2) (S18.1, S18.2, and S18.3).

Because the superframe index value of the node 5 that is extracted from the superframe slot use notification message is “5” and is larger than a representative superframe index value thereof of “4”, the N44, having received the superframe slot use notification message that is broadcasted from the N55, changes and sets a representative superframe index value thereof from “4” to “5” and maintains a superframe index value thereof “4” (S19.1).

Further, because a representative superframe index value that is extracted from the superframe slot use notification message is “5” and is larger than a representative superframe index value thereof of “4”, the N22, having received the superframe slot use notification message that is broadcasted from the N55, changes and sets a representative superframe index value thereof from “4” to “5” and maintains a superframe index value of “2” (S19.2).

Further, because the superframe index value of the node 5 from the superframe slot use notification message is “5” and is larger than a representative superframe index value thereof of “3”, the N33, having received the superframe slot use notification message that is broadcasted from the N55, changes and sets a representative superframe index value thereof from “3” to “5” and maintains a superframe index value of “3” (S19.3).

The N33, having received a connection request message from the N66, transmits a candidate superframe slot notification message including a candidate slot value of “6” that is an increase of a representative superframe index value thereof of “5” by +1 to the N66 (S20).

The N66, having received the candidate superframe slot notification message from the N33, sets a representative superframe index value thereof to “6” and a superframe index value thereof to “6” according to a candidate slot value (S21). The N66 broadcasts a superframe slot use notification message including a superframe value thereof, parent ID (here, ID of the node 3), and a superframe index value of a parent node (here, a superframe index value “3” of the node 3) (S22.1 and S22.2).

Because a superframe index value of the node 6 that is extracted from the superframe slot use notification message is “6” and is larger than a representative superframe index value thereof “5”, the N55, having received the superframe slot use notification message that is broadcasted from the N66 changes and sets a representative superframe index value thereof from “5” to “6” and maintains a superframe index value of “5” (S23.1). Further, because the superframe index value of the node 6 that is extracted from the superframe slot use notification message is “6” and is larger than a representative superframe index value thereof of “5”, the N33, having received the superframe slot use notification message that is broadcasted from the N66, changes and sets a representative superframe index value thereof from “5” to “6” and maintains a superframe index value of “3” (S23.2).

In this way, in a state in which the N44, N55, and N66 enter a network, in order for a node 7 (N77), a node 8 (N88), a node 9 (N99), and a node 10 (N10) to enter the network, the N77, N88, N99, and N10 broadcast a connection request message (S24.1, S24.2, S24.3, S24.4, S24.5, and S24.6).

The N44, having received a connection request message from the N77, transmits a candidate superframe slot notification message including a candidate slot value “6” that increases by +1 from a representative superframe value thereof of “5” to the N77 (S25).

The N77, having received the candidate superframe slot notification message from the N44, sets a representative superframe index value thereof to “6” and a superframe index value thereof to “6” according to a candidate slot value (S26). The N77 broadcasts a superframe slot use notification message including the superframe index value thereof, parent ID (here, ID of the node 4), and a superframe index value of a parent node (here, a superframe index value of the node 4) (S27).

Because the superframe index value of the node 7 that is extracted from the superframe slot use notification message is “6” and is larger than a representative superframe index value thereof of “5”, the N44, having received the superframe slot use notification message that is broadcasted from the N77, changes and sets a representative superframe index value thereof from “5” to “6” and maintains a superframe index value of “4” (S28).

Further, the N44, having received a connection request message from the N88, transmits a candidate superframe slot notification message including a candidate slot value “7” that is an increase of a representative superframe index value thereof of “6” by +1 to the N88 (S29).

The N88, having received the candidate superframe slot notification message, sets a representative superframe index value thereof to “7” and a superframe index value thereof to “7” according to a candidate slot value (S30). The N88 broadcasts a superframe slot use notification message including the superframe index value thereof, parent ID (here, ID of the node 4), and a superframe index value of a parent node (here, a superframe index value of the node 4) (S31.1, S31.2, and S31.3).

Because the superframe index value “7” of the node 8 that is extracted from the superframe slot use notification message is larger than a representative superframe index value thereof of “6”, the N77, having received the superframe slot use notification message from the N88, changes and sets a representative superframe index value thereof from “6” to “7” and maintains a superframe index value thereof of “6” (S32.1).

Further, because the superframe index value “7” of the node 8 that is extracted from the superframe slot use notification message is larger than a representative superframe index value thereof of “6”, the N44, having received the superframe slot use notification message from the N88, changes and sets a representative superframe index value thereof from “6” to “7” and maintains a superframe index value of “4” (S32.2).

Further, because the superframe index value of the node 8 that is extracted from the superframe slot use notification message is “7” and is larger than a representative superframe index value thereof of “6”, the N55, having received the superframe slot use notification message from the N88, changes and sets a representative superframe index value thereof from “6” to “7” and maintains a superframe index value of “5” (S32.3).

The N55, having received a connection request message from the N99, transmits a candidate superframe slot notification message including a candidate slot value “8” that is an increase of a representative superframe index value thereof by +1 from “7” to the N99 (S33).

The N99, having received the candidate superframe slot notification message, sets a representative superframe index value thereof to “8” and a superframe index value thereof to “8” according to a candidate slot value (S34). The N99 broadcasts a superframe slot use notification message including a superframe index value thereof, parent ID (here, ID of the node 5), and a superframe index value of a parent node (here, the superframe index value of the node 5) (S35.1, S35.2, and S35.3).

Because the superframe index value “8” of the node 9 that is extracted from the superframe slot use notification message is larger than a representative superframe index value thereof of “7”, the N88, having received the superframe slot use notification message that is broadcasted from the N99, changes and sets a representative superframe index value thereof from “7” to “8” and maintains a superframe index value of “7” (S36.2).

Further, because the superframe index value “8” of the node 9 that is extracted from the superframe slot use notification message is larger than a representative superframe index value thereof of “7”, the N55, having received the superframe slot use notification message that is broadcasted from the N99, changes and sets a representative superframe index value thereof from “7” to “8” and maintains a superframe index value of “5” (S36.2).

Further, because the superframe index value “8” of the node 9 that is extracted from the superframe slot use notification message is larger than a representative superframe index value thereof of “6”, the N66, having received the superframe slot use notification message that is broadcasted from the N99, changes and sets a representative superframe index value thereof from “6” to “8” and maintains a superframe index value of “6” (S36.3).

The node 66, having received a connection request message from the N10, transmits a candidate superframe slot notification message including a candidate slot value of “9” that is an increase of a representative superframe index value thereof of “8” by +1 to the N10 (S37).

The N10, having received the candidate superframe slot notification message, sets a representative superframe index value thereof to “9” and a superframe index value thereof to “9” according to a candidate slot value (S38). The N10 broadcasts a superframe slot use notification message including a superframe index value thereof, parent ID (here, ID of the node 6), and a superframe index value of a parent node (here, the superframe index value of the node 6) (S39.1 and S39.2).

Because the superframe index value “9” of the node 10 that is extracted from the superframe slot use notification message is larger than a representative superframe index value thereof of “8”, the N99, having received the superframe slot use notification message that is broadcasted from the N10, changes and sets a representative superframe index value thereof from “8” to “9” and maintains a superframe index value of “8” (S40.1).

Further, because the superframe index value “9” of the node 10 that is extracted from the superframe slot use notification message is larger than a representative superframe index value thereof of “8”, the N66, having received the superframe slot use notification message that is broadcasted from the N10, changes and sets a representative superframe index value thereof from “8” to “9” and maintains a superframe index value of “6” (S40.2).

By transmitting only slot information (e.g., 2 bytes) corresponding to a candidate slot to each candidate superframe slot notification message through such a process, a beacon slot size can be reduced and fixed.

Further, because only a representative superframe index of a fixed size (e.g., 1 byte or 2 bytes) is used, each node can use minimal storage space, compared with a case of depending on the bitmap in order to store superframe index information of adjacent nodes.

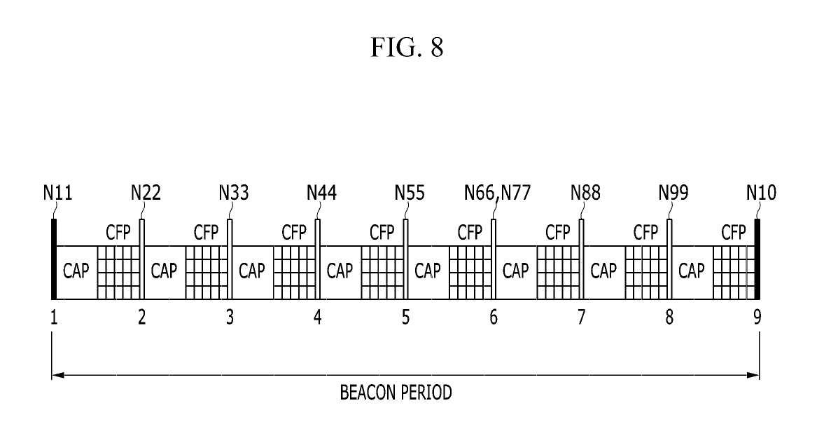

FIG. 8 is a diagram illustrating a superframe slot that is allocated to each node according to beacon scheduling of FIG. 7.

Referring to FIG. 8, after beacon scheduling according to an exemplary embodiment of the present invention is performed, the N11 is allocated to a slot 1, the N22 is allocated to a slot 2, the N33 is allocated to a slot 3, the N44 is allocated to a slot 4, the N55 is allocated to a slot 5, the N66 and N77 are allocated to a slot 6, the N88 is allocated to a slot 7, the N99 is allocated to a slot 8, and the N10 is allocated to a slot 9.

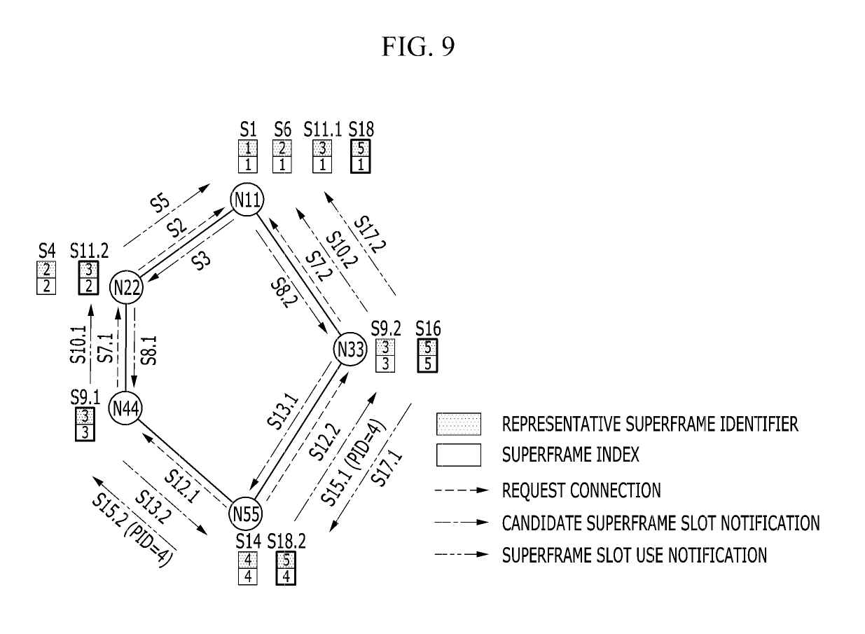

FIG. 9 is a diagram illustrating a process in which a beacon collision is avoided according to a method of performing beacon scheduling according to an exemplary embodiment of the present invention.

According to an exemplary embodiment of the present invention, a slot can be reused between nodes having no interference. When interference occurs due to nodes that do not hear each other, a superframe slot in which a parent node that first enters a network provides is allocated to the node, the node broadcasts superframe use notification including ID information of the parent node. A node, having received the superframe use notification, senses a node using the same superframe index as that thereof while having a different ID from that thereof, and newly sets a superframe index thereof to a value that increases by a predetermined value (+1) from a value that is included in a present message that receives notification, thereby avoiding a beacon collision.

More specifically, in an environment of FIG. 9, like FIG. 3, for example, in a state in which the N11 sets a representative superframe index value thereof to “1” and a superframe index value thereof to “1” (S1), when the N11 receives a connection request message that is broadcasted from the N22 (S2), the N11 transmits a candidate superframe slot notification message including a candidate slot value “2” to the N22 (S3). Accordingly, the N22 sets a representative superframe index value thereof to “2” and a superframe index value thereof to “2” (S4), and broadcasts a superframe slot use notification message including a superframe index value thereof of “2”, parent ID (ID of the node 1), and a superframe index value “1” of the node 1, which is a parent node (S5). The N11, having received the superframe slot use notification message changes a representative superframe index value thereof to “2” and maintains a superframe index value of “1” (S6).

In this way, in a state in which the N22 enters the network, when the N44 and N33 broadcast a connection request message (S7.1 and S7.2), the N22 transmits a candidate superframe slot notification message including a candidate slot value “3” that is an increase of a representative superframe index value thereof of “2” by +1 to the N44 according to a connection request message from the N44 (S8.1).

Further, the N11, having received a node connection request message from the N33, transmits a candidate superframe slot notification message including a candidate slot value “3” that is an increase of a representative superframe index value thereof of “2” by +1 to the N33 (S8.2).

The N44, having received the candidate superframe slot notification message from the N22, sets a representative superframe index value thereof to “3” and a superframe index value thereof to “3” (S9.1). Further, the N33, having received the candidate superframe slot notification message from the N11, sets a representative superframe index value thereof to “3” and a superframe index value thereof to “3” (S9.2).

The N44 broadcasts a superframe slot use notification message including a superframe index value thereof of “3”, parent ID (ID of the node 2), and a superframe index value “2” of the node 2, which is a parent node (S10.1). The N33 broadcasts a superframe slot use notification message including a superframe index value thereof of “3”, parent ID (ID of the node 2), and a superframe index value “2” of the node 2, which is a parent node (S10.2).

Because the superframe index value “3” of the node 4 that is extracted from the message is larger than a representative superframe index value thereof of “2”, the N22, having received the superframe slot use notification message from the N44, sets a representative superframe index value thereof from “2” to “3”. Because the parent ID that is extracts from the message and the ID of the N22 are the same, the N22 maintains a superframe index value of “2” (S11.2).

Further, because the superframe index value “3” of the node 4 that is extracted from the message is larger than a representative superframe index value thereof of “2”, the N11, having received the superframe slot use notification message from the N33, sets a representative superframe index value thereof from “2” to “3”, and the parent ID that is extracted from the message and the ID of the N11 are not the same, but because the superframe index value “2” of the node 2, which is a parent node that is extracted from the message, is the same as a superframe index value of the N11, the N11 maintains a superframe index value of “1” (S11.1).

In such a state, when the N55 broadcasts a connection request message (S12.1 and S12.2), the N44 and N33, having received the connection request message, each transmit a candidate superframe slot notification message to the N55 (S13.1 and S13.2). Here, a candidate slot value “4” that is an increase of a representative superframe index value “3” of the N44 by +1 is included in the candidate superframe slot notification message that is transmitted from the N44, and a candidate slot value “4” that is an increase of the representative superframe index value “3” of the N33 by +1 is included in the candidate superframe slot notification message that is transmitted from the N33.

The N55, having received the candidate superframe slot notification message that is transmitted from the N44, sets a representative superframe index value thereof to “4” and a superframe index value thereof to “4” (S14), and broadcasts a superframe slot use notification message including a superframe index value thereof of “4”, parent ID (here, ID of the node 4), and a superframe index value “3” of the node 4, which is a parent node (S15.1 and S15.2).

Because the superframe index value of the node 5 that is extracted from the superframe slot use notification message is “4” and is larger than a representative superframe index value thereof of “3”, the N44, having received the superframe slot use notification message that is broadcasted from the N55, changes a representative superframe index value thereof to “4”. Because the ID of the N44 and the parent ID that is extracted from the message are the same, the N44 maintains a superframe index value of “3” (S9.1).

Because the index value of the node 5 that is extracted from the superframe slot use notification message is “4” and is larger than a representative superframe index value thereof of “3”, the N33, having received the superframe slot use notification message that is broadcasted from the N55, sets a representative superframe index value thereof to “4”. However, because the parent ID that is extracted from the slot use notification message is not the same as the ID of the N33, and a superframe index value “3” of the node 4, which is a parent node that is extracted from the message is the same as a superframe index value thereof of “3”, the N33 sets a representative superframe index value thereof that was set to “4” to “5” by again increasing it by a predetermined value, i.e., +1. The N33 sets a superframe index value thereof to “5” according to the changed representative superframe index value (S16).

The N33 broadcasts a superframe slot use notification message including a superframe index value thereof “5”, parent ID (here, the node 5), and a superframe index value of the parent node (here, a superframe index value “4” of the node 5) (S17.1 and S17.2). Because the superframe index value “5” of the node 3 that is extracted from the message is larger than a representative superframe index value thereof of “3”, the N11, having received the superframe slot use notification message from the node 3, sets the representative superframe index value thereof from “3” to “5”. The parent ID that is extracted from the message and the ID of the N11 are different, but because the superframe index value “4” of the node 5, which is a parent node that is extracted from the message is different from a superframe index value thereof of “1”, the N11 maintains a superframe index value of “1” (S18).

Further, because the superframe index value “5” of the node 3 that is extracted from the message is larger than a representative superframe index value of the N55 of “4”, the N55, having received the superframe slot use notification message from the node 3, sets a representative superframe index value thereof from “4” to “5”. Because the parent ID that is extracted from the message and the ID of the N55 are the same, the N55 maintains a superframe index value of “4” (S18.2).

In this way, according to an exemplary embodiment of the present invention, by allowing nodes that are separated by 2 hops or more to use the same slot while allocating a slot without a beacon collision between nodes based on mutual cooperation, a latent beacon collision possibility can be prevented.

In order to perform such beacon scheduling, each device according to an exemplary embodiment of the present invention includes the following beacon scheduling apparatus.

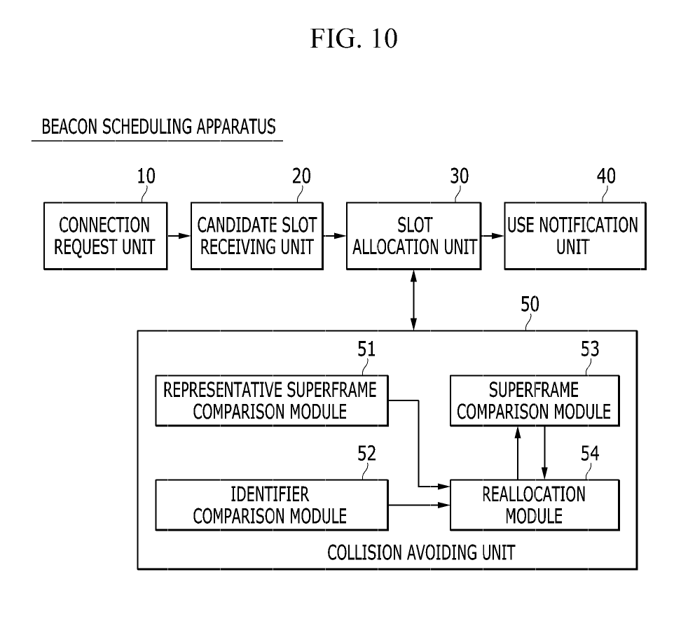

FIG. 10 is a block diagram illustrating a configuration of a beacon scheduling apparatus according to an exemplary embodiment of the present invention.

As shown in FIG. 10, the beacon scheduling apparatus according to an exemplary embodiment of the present invention includes a connection request unit 10, a candidate slot receiving unit 20, a slot allocation unit 30, a use notification unit 40, and a collision avoiding unit 50.

The connection request unit 10 broadcasts a connection request message that requests a connection to a wireless network, and broadcasts a connection request message in order over all channels according to CSMA/CA.

The candidate slot receiving unit 20 receives a candidate superframe slot notification message including a candidate slot value from a device that has already joined a wireless network and transfers the received message to the slot allocation unit 30. The candidate slot value is set according to a representative superframe index value that a device that transmits the candidate superframe slot notification message manages.

The slot allocation unit 30 sets a representative superframe index value and a superframe index value according to a candidate slot value that is extracted from the candidate superframe slot notification message.

The use notification unit 40 generates and broadcasts a superframe use notification message including a superframe index value that is set by the slot allocation unit 30, an identifier, i.e., parent ID of a device that transmits a candidate superframe slot notification message, and a superframe index value of a device that transmits a candidate superframe slot notification message.

When the collision avoiding unit 50 receives a superframe use notification message from another device, the collision avoiding unit 50 determines whether a superframe index value thereof should be changed based on a superframe index value of another device that is extracted from the received message and selectively changes a superframe index value thereof according to a determination result, thereby avoiding a beacon collision.

For this purpose, the collision avoiding unit 50 includes a representative superframe comparison module 51, an identifier comparison module 52, a superframe comparison module 53, and a reallocation module 54 that selectively resets a representative superframe index value and a superframe index value thereof according to a result of each of the comparison modules 51, 52, and 53.

The representative superframe comparison module 51 compares a superframe index value that is extracted from a received superframe use notification message and a representative superframe index value thereof.

The identifier comparison module 52 compares the parent ID that is extracted from a received superframe use notification message and the ID thereof.

The superframe comparison module 53 compares a superframe index value that is extracted from a received superframe use notification message and a superframe index value thereof. If a superframe index value that is extracted from a superframe use notification message that is received by the representative superframe comparison module 51 is not larger than a representative superframe index value thereof, and if the parent ID that is extracted from a superframe use notification message that is received by the identifier comparison module 52 and the ID thereof do not correspond, the superframe comparison module 53 operates.

The reallocation module 54 selectively resets a representative superframe index value and a superframe index value thereof according to results of each of the comparison modules 51, 52, and 53.

Specifically, if a superframe index value that is extracted from a superframe use notification message that is received by the representative superframe comparison module 51 is larger than a representative superframe index value thereof, the reallocation module 54 sets a value that is an increase of a representative superframe index value thereof by a predetermined value (e.g., +1) as a candidate value, and if the parent ID that is extracted from a superframe use notification message that is received by the identifier comparison module 52 and the ID thereof correspond, the reallocation module 54 finally sets the candidate value to a representative superframe index value thereof, and a superframe index value thereof maintains an existing value.

Further, after the candidate value is set, if the parent ID that is extracted from the superframe use notification message that is received by the identifier comparison module 52 and the ID thereof do not correspond, the reallocation module 54 receives a determination result by operating the superframe comparison module 53. If a superframe index value thereof and a superframe index value of a parent node that is extracted from the received message are not the same, the reallocation module 54 finally sets the candidate value as a representative superframe index value thereof, and a superframe index value thereof maintains an existing value. If a superframe index value thereof and a superframe index value of the parent node that is extracted from the received message are the same, the reallocation module 54 resets a representative superframe index value by again increasing a representative superframe index value thereof that is changed according to the candidate value by a predetermined value (e.g., +1). The reallocation module 54 changes and resets a superframe index value thereof according to the reset representative superframe index value.

Further, as a check result by the representative superframe comparison module 51, the superframe index value that is extracted from the received superframe use notification message is not larger than a representative superframe index value thereof, but if the parent ID that is extracted from the superframe use notification message that is received by the identifier comparison module 52 and the ID thereof correspond, the reallocation module 54 maintains each of a representative superframe index value and a superframe index value thereof at existing values.

Further, as a check result by the representative superframe comparison module 51, the superframe index value that is extracted from the received superframe use notification message is not larger than a representative superframe index value thereof, but if the parent ID that is extracted from the superframe use notification message that is received by the identifier comparison module 52 and the ID thereof do not correspond, the reallocation module 54 receives a check result by operating the superframe comparison module 53.

If a superframe index value thereof and a superframe index value of the parent node that is extracted from the received message are the same, the reallocation module 54 increases a representative superframe index value thereof by predetermined value (e.g., 1), and changes and resets a superframe index value thereof according to the increased value.

If a superframe index value thereof and a superframe index value of a parent node that is extracted from the received message are not the same, the reallocation module 54 maintains the representative superframe index value and the superframe index value thereof at existing values.

According to an exemplary embodiment of the present invention, in a mesh-based wireless communication system, beacon scheduling is performed with a representative superframe slot index and an active connection request method. As a result, by performing an active network connection instead of a manual network connection method that depends on a periodic beacon, network forming time can be shortened.

Further, because only a representative superframe index of a fixed size (e.g., 1 byte or 2 bytes) is used, a minimum storage space can be used, and particularly, a problem of difficulty of network size estimation when depending on a bitmap in order to store superframe index information of adjacent nodes, and a problem that a bitmap size is proportional to a network size, can be solved.

Further, by previously allocating a candidate slot to a node that requests slot allocation and by transmitting only corresponding slot information, a size of a beacon slot can be fixed or can be reduced.

Further, because a mutual cooperation-based dispersed type of slot allocation method is used, the same slot can be used between nodes that are separated by 2 hops or more. Therefore, a use rate of a superframe slot can be increased without collision between nodes.

Further, a node using the same slot is searched for through an active network participation function, and by notifying a corresponding node of this, another slot can be allocated and thus a latent beacon collision possibility can be solved.

Further, a variable that is used for beacon scheduling is simplified, and by removing overhead that should compare slot values of all adjacent nodes every time, the algorithm can super lightweight.

An exemplary embodiment of the present invention may not only be embodied through the above-described apparatus and/or method, but may also embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of performing beacon scheduling in a wireless network, the method comprising:
transmitting, by a first device to enter the wireless network, a connection request message;
receiving, by the first device, a candidate superframe slot notification message comprising a candidate slot value from a second device that receives the connection request message; and
allocating, by the first device, a superframe slot according to the candidate slot value.

2. The method of claim 1, wherein in the transmitting of a connection request message, the first device broadcasts the connection request message as soon as the first device is in a wakeup state, and,
wherein the receiving of a candidate superframe slot notification message includes transmitting, by a device that has already entered the wireless network among devices, having received the connection request message, the candidate superframe slot notification message.

3. The method of claim 1, wherein the first device transmits the connection request message over all channels and receives the candidate superframe slot notification message after a predetermined time has elapsed.

4. The method of claim 1, wherein each device that enters the wireless network manages index information comprising a superframe index value of a superframe that is allocated to transmit a beacon signal of adjacent nodes and a representative superframe index value for beacon scheduling.

5. The method of claim 1, wherein the allocating of a superframe slot comprises:
setting, by the first device, a representative superframe index value thereof according to the candidate slot value; and
setting, by the first device, a superframe index value thereof and allocating a superframe according to the candidate slot value.

6. The method of claim 1, further comprising broadcasting, by the first device, a superframe use notification message comprising information about the allocated superframe.

7. The method of claim 6, wherein the first device comprises an index value of the allocated superframe, an identifier of a parent node, which is a device that transmits the candidate superframe slot notification message, and a superframe index value of the parent node in the superframe use notification message, and transmits the superframe use notification message.

8. The method of claim 7, further comprising:
receiving, by the first device, a superframe use notification message comprising information about a superframe that is allocated from another device; and
selectively changing, by the first device, a superframe index value thereof based on a superframe index value that is included in the superframe use notification message.

9. A method of performing beacon scheduling in a wireless network, the method comprising:
receiving, by a second device that enters the wireless network, a connection request message from a first device;
setting, by the second device, a value that is a sum of a preset value and a representative superframe index value thereof as a candidate slot value; and
transmitting, by the second device, a candidate superframe slot notification message comprising a candidate slot value and an identifier thereof to the first device.

10. The method of claim 9, further comprising:
receiving, by the second device, a superframe use notification message comprising information that is related to superframe slot allocation of a network device from the network device comprising the first device; and
selectively changing, by the second device, superframe allocation thereof based on the information that is included in the superframe use notification message.

11. The method of claim 10, wherein the information that is included in the superframe use notification message comprises a superframe index value corresponding to a superframe that is allocated to the network device, an identifier of a parent node of the network device, and a superframe index value corresponding to a superframe that is allocated to the parent node.

12. The method of claim 11, wherein the selectively changing of superframe allocation comprises:
first comparing of comparing a superframe index value of the network device that is extracted from the received superframe use notification message and a representative superframe index value of the second device;
second comparing of comparing a parent identifier that is extracted from the received superframe use notification message and an identifier of the second device;
third comparing of comparing a superframe index value of a parent node of the network device that is extracted from the received superframe use notification message and a superframe index value of the second device; and
selectively resetting a representative superframe index value of the second device and a superframe index value of the second device based on at least one of a comparison result of the first comparing, a comparison result of the second comparing, and a comparison result of the third comparing.

13. The method of claim 12, wherein the selectively resetting of a representative superframe index value comprises at least one of:
first resetting of maintaining each of a representative superframe index value of the second device and a superframe index value of the second device at existing values;
second resetting of resetting a representative superframe index value of the second device by increasing by a predetermined value according to a preset value and maintaining a superframe index value of the second device at an existing value; and
third resetting by increasing the representative superframe index value of the second device according to a preset first value, resetting a representative superframe index value that is increased according to the first value to the reset representative superframe index value of the second device by increasing according to a preset second value, and resetting a superframe index value of the second device according to the reset representative superframe index value of the second device.

14. The method of claim 13, wherein the first resetting is performed when satisfying one of:
a first condition in which a superframe index value of the network device that is included in the received superframe use notification message is not larger than a representative superframe index value of the second device and in which a parent identifier corresponds with an identifier of the second device; and
a second condition in which a superframe index value of the network device that is included in the received superframe use notification message is not larger than a representative superframe index value of the second device and in which the parent identifier does not correspond with an identifier of the second device and in which a superframe index value of the network device that is included in the received superframe use notification message does not correspond with a superframe index value of the second device.

15. The method of claim 13, wherein the second resetting is performed when satisfying one of:
a third condition in which a superframe index value of the network device that is included in the received superframe use notification message is larger than a representative superframe index value of the second device and in which the parent identifier corresponds with an identifier of the second device; and
a fourth condition in which a superframe index value of the network device that is included in the received superframe use notification message is larger than a representative superframe index value of the second device and in which the parent identifier does not correspond with an identifier of the second device and in which a superframe index value of the network device that is included in the received superframe use notification message does not correspond with a superframe index value of the second device.

16. The method of claim 13, wherein the third resetting is performed when satisfying
a fifth condition in which a superframe index value of the network device that is included in the received superframe use notification message is larger than a representative superframe index value of the second device and in which the parent identifier does not correspond with an identifier of the second device and in which a superframe index value of the network device that is included in the received superframe use notification message corresponds with a superframe index value of the second device.

17. An apparatus that performs beacon scheduling in a wireless network, the apparatus comprising:
a connection request unit that broadcasts a connection request message that requests a connection to the wireless network;
a candidate slot receiving unit that receives a candidate superframe slot notification message comprising a candidate slot value from a device that has already joined the wireless network; and
a slot allocation unit that that performs superframe allocation according to a candidate slot value that is extracted from the candidate superframe slot notification message,
wherein the candidate slot value is a value that is a sum of a preset value and a representative superframe index value corresponding to a superframe that is allocated to a device that transmits the candidate superframe slot notification message.

18. The apparatus of claim 17, further comprising a use notification unit that generates and broadcasts a superframe use notification message comprising a superframe index value corresponding to superframe allocation by the slot allocation unit and an identifier of a device that transmits the candidate superframe slot notification message and a superframe index value of a device that transmits the candidate superframe use notification message.

19. The apparatus of claim 18, further comprising a collision avoiding unit that, when a superframe use notification message is received from another device on the wireless network, determines whether to change a superframe index value thereof based on a superframe index value of another device that is extracted from the received message and that selectively changes a superframe index value thereof according to a determination result.

20. The apparatus of claim 19, wherein the collision avoiding unit comprises:
a representative superframe comparison module that compares a superframe index value that is extracted from the received superframe use notification message and a representative superframe index value thereof;
an identifier comparison module that compares an identifier that is extracted from the received superframe use notification message and an identifier thereof;
a superframe comparison module that compares a superframe index value of a device that transmits the candidate superframe slot notification message that is extracted from the received superframe use notification message and a superframe index value thereof; and
a reallocation module that selectively resets a representative superframe index value thereof and a superframe index value according to results of each of the comparison modules.
